(19) United States
(12) Patent Application Publication
(10) Pub. No.: US 2026/0168399 A1
(43) Pub. Date: Jun. 18, 2026

(54) METHOD FOR WASHING GAS TURBINE ENGINES

(71) Applicant: General Electric Company, Evendale, OH (US)

(72) Inventors: Srinivasan Swaminathan, Bengaluru (IN); Shalini Thimmegowda, Bengaluru (IN); Sanjeev Kumar Jha, Bangalore (IN)

(21) Appl. No.: 19/259,064

(22) Filed: Jul. 3, 2025

(30) Foreign Application Priority Data
Dec. 13, 2024 (IN) 202411098693

(51) Int. Cl. F01D 25/00; B01F 25/31; B01F 101/24

(52) U.S. Cl. CPC F01D 25/002; B01F 25/31114; B01F 2101/24; F05D 2220/32

(57) ABSTRACT

A method for washing a gas turbine engine includes freezing a cleaning liquid to form solid cleaning granules, compacting the solid cleaning granules to form a compacted cleaning solid, and inserting the compacted cleaning solid into the gas turbine engine, wherein when the gas turbine engine is started, the compacted cleaning solid liquifies to form a cleaning foam, which spreads through a gas flow path of the gas turbine engine to clean one or more components of the gas turbine engine along the gas flow path.

### FIELD

The present disclosure is related to gas turbine engines and, more specifically, to methods for washing gas turbine engines.

### BACKGROUND

A gas turbine engine typically includes a fan and a turbomachine. The turbomachine generally includes an inlet, one or more compressors, a combustor, and one or more turbines. The compressor(s), in turn, compress air, which is routed to the combustor where it is mixed with fuel. The mixture is then ignited, generating hot combustion gases. The combustion gases are then routed to the turbine(s), which extracts energy from the combustion gases, such as for use in powering the compressor(s) and generating thrust to propel an aircraft in flight. Additionally, the turbomachine is mechanically coupled to the fan for driving the fan during operation.

During operation, a substantial amount of air is ingested by the gas turbine engine. Such air may contain foreign particles. While a majority of the foreign particles will follow the gas flow path through the engine and exit with the exhaust gases, at least a portion of these particles may stick to certain components along the gas flow path. This, in turn, can change aerodynamic and/or thermal properties of the engine and potentially impact engine performance.

To remove such foreign particles from within the gas flow path of the gas turbine engine, a washing operation may be performed. During the washing operation, water and/or other liquids are directed into and flow through the gas turbine engine. However, due to their nature, washing operations are generally performed infrequently. Infrequent washing operations, in turn, generally require large quantities of water, often with detergent additives, which generate large amounts of effluent flow. In instances in which the washing operation uses detergent additives, the effluent flow must be contained and disposed of.

### BRIEF DESCRIPTION OF THE DRAWINGS

A full and enabling disclosure of the present disclosure, including the best mode thereof, directed to one of ordinary skill in the art, is set forth in the specification, which refers to the appended figures, in which:

FIG. 1 is a schematic cross-sectional view of one embodiment of a gas turbine engine in accordance with aspects of the present disclosure.

FIG. 2 is a diagrammatic view of one embodiment of a delivery tool for delivering a compacted cleaning solid into a gas flow path of a gas turbine engine in accordance with aspects of the present disclosure.

FIG. 3 is a flow diagram of one embodiment of a method for washing a gas turbine engine in accordance with aspects of the present subject matter.

FIG. 4 is a flow diagram of one aspect of the method shown in FIG. 3.

FIG. 5 is a diagrammatic view of an implementation of a portion of the method shown in FIG. 3.

FIG. 6A is a diagrammatic view of one embodiment of a compacted cleaning solid in accordance with aspects of the present subject matter.

FIG. 6B is a diagrammatic view of another embodiment of a compacted cleaning solid in accordance with aspects of the present subject matter.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context dictates otherwise.

The term “at least one of” in the context of, e.g., “at least one of A, B, and C” refers to only A, only B, only C, or any combination of A, B, and C.

The terms “coupled,” “fixed,” “attached to,” and the like refer to both direct coupling, fixing, or attaching, as well as indirect coupling, fixing, or attaching through one or more intermediate components or features unless otherwise specified herein.

As used herein, the terms “first,” “second,” and “third” may be used interchangeably to distinguish one component from another and are not intended to signify the location or importance of the individual components.

For purposes of the description hereinafter, the terms “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered limiting.

The term “turbomachine” refers to a machine including one or more compressors, a heat-generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or another appropriate heat addition assembly. In certain example embodiments, the combustion section may include an annular combustor, a can combustor, a cannular combustor, a trapped vortex combustor (TVC), or other appropriate combustion system, or combinations thereof.

The terms “low” and “high”, or their respective comparative degrees (e.g., –er, where applicable), when used with a compressor, a turbine, a shaft, or spool components, etc. each refer to relative speeds within an engine unless otherwise specified. For example, a “low turbine” or “low-speed turbine” defines a component configured to operate at a rotational speed, such as a maximum allowable rotational speed, lower than a “high turbine” or “high-speed turbine” of the engine.

The terms “forward” and “aft” refer to relative positions within a gas turbine engine or vehicle, and are based on a normal operational attitude of the gas turbine engine or vehicle. More particularly, forward and aft are used herein with reference to the direction of travel of the vehicle and the direction of propulsive thrust of the gas turbine engine.

The terms “upstream” and “downstream” refer to the relative direction with respect to fluid flow in a fluid pathway. For example, “upstream” refers to the direction from which the fluid flows, and “downstream” refers to the direction in which the fluid flows.

As used herein, the terms “axial” and “axially” refer to directions and orientations that extend substantially parallel to a centerline of the gas turbine engine. Moreover, the terms “radial” and “radially” refer to directions and orientations that extend substantially perpendicular to the centerline of the gas turbine engine. In addition, as used herein, the terms “circumferential” and “circumferentially” refer to directions and orientations that extend arcuately about the centerline of the gas turbine engine.

In general, the present subject matter is directed to a method for washing a gas turbine engine, such as to remove foreign particles from the gas turbine engine. Specifically, in several embodiments, the method includes freezing a cleaning liquid to form solid cleaning granules. The cleaning liquid, in turn, may be liquid detergent, a mixture of liquid detergent and liquid water, etc. For example, in some embodiments, the cleaning liquid may be frozen by exposing the cleaning liquid to liquid nitrogen. Furthermore, the method includes compacting the solid cleaning granules to form a compacted cleaning solid, such as a sphere(s) and/or a cuboid(s). Additionally, the method includes inserting the compacted cleaning solid into the gas turbine engine, such as through the inlet or mouth of the gas turbine engine.

Moreover, in several embodiments, a delivery tool may be used to deliver a compacted cleaning solid into the gas flow path of a gas turbine engine. For example, in some embodiments, the delivery tool includes a base member and an insertion member that is slidable relative to the base member. The insertion member, in turn, is configured to hold the compacted cleaning solid for eventual placement of the compacted cleaning solid into the gas flow path. In addition, the delivery tool includes a stopper configured to set the distance into the gas flow path that the insertion member places the compacted cleaning solid.

Placing a compacted cleaning solid into the gas turbine engine improves the washing operation. More specifically, during conventional washing operations, liquid water and/or liquid detergent is supplied to the engine to perform the washing operation. However, the use of liquid water and/or liquid detergents can be time-consuming. In this respect, finding a long enough time slot to perform such a washing operation can be difficult while an aircraft is in routine service (e.g., between one arrival and the next departure.) Thus, such operations are performed infrequently. Infrequent washing may allow more particulates to build up, requiring the use larger quantities of water and/detergent. This, in turn, generates large amounts of effluent flow that, in certain instances,be contained and disposed of. However, by using a compacted cleaning solid, the washing operation can be performed more frequently. Specifically, after the compacted compacted solid is inserted into the gas turbine engine and th engine is started, the heat and mechanical agitation from engine cause the compacted cleaning solid to break apart and melt. Thus, this process can be performed more quickly and more frequently than traditional washes, which helps keep the engine cleaner and reduces time-on-ground. Additionally, more frequent washing operations use less water and/or detergent, thereby generating smaller effuents. Moreover, the engine is kept more clean than with conventional methods, the engine performs better and requires less maintenance and the less pollution in and around the irport.

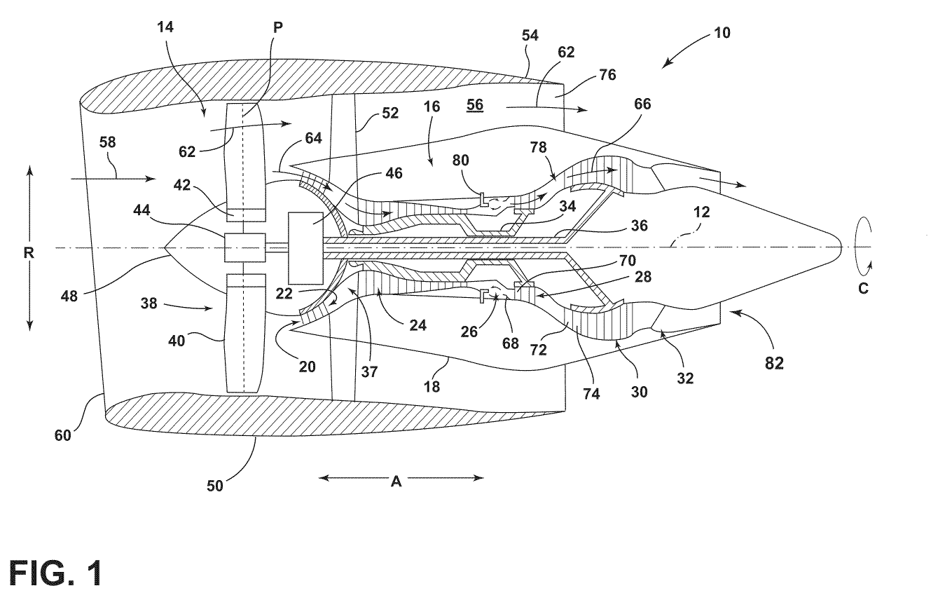

Referring now to the drawings, wherein identical numerals indicate the same elements throughout the figures, FIG. 1 is a schematic cross-sectional view of one embodiment of a gas turbine engine 10. More specifically, in the illustrated embodiment, the gas turbine engine 10 is a high-bypass turbofan jet engine, sometimes also referred to as a “turbofan engine.” As shown in FIG. 1, the gas turbine engine 10 defines an axial direction A (extending parallel to a longitudinal centerline 12 provided for reference), a radial direction R, and a circumferential direction C extending about the longitudinal centerline 12. In general, the gas turbine engine 10 includes a fan section 14 and a turbomachine 16 disposed downstream of the fan section 14.

The turbomachine 16 generally includes a substantially tubular outer casing 18 that defines an annular inlet 20. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high-pressure (HP) shaft 34 (which may additionally or alternatively be a spool) drivingly connects the HP turbine 28 to the HP compressor 24. A low-pressure (LP) shaft 36 (which may additionally or alternatively be a spool) drivingly connects the LP turbine 30 to the LP compressor 22. The compressor section, the combustion section 26, the turbine section, and the jet exhaust nozzle section 32 together define a gas flow path 37.

The respective casings of the booster or LP compressor 22, the HP compressor 24, the combustor 26, the HP turbine 28, and the LP turbine 30 may include access ports to enable inspection and/or maintenance activities to be performed while the gas turbine engine 10 is not in use. These access ports are generally referred to as borescope ports, due to their frequent use for borescope inspection. However, these ports may also provide access into the gas flow path 37 of the gas turbine engine 10 for other purposes. The borescope ports extend generally radially relative to the gas turbine engine 10, and are disposed along the length of the gas turbine engine 10 to provide access to the blades, bliscs and discs within the gas turbine engine 10 at certain axial stages along the gas turbine engine 10. To close the casings to enable the gas turbine engine 10 to be operated, each borescope port is equipped with a borescope port plug which can be installed to close each borescope port of the gas turbine engine 10, or removed to enable inspection and maintenance of the gas turbine engine 10.

In the illustrated embodiment, the fan section 14 includes a fan 38 having a plurality of fan blades 40 coupled to a disk 42 in a spaced apart manner. As depicted, the fan blades 40 extend outwardly from disk 42 generally along the radial direction R. Each fan blade 40 is rotatable relative to the disk 42 about a pitch axis P by the fan blades 40 being operatively coupled to a suitable pitch change mechanism 44 configured to collectively vary the pitch of the fan blades 40, e.g., in unison. The gas turbine engine 10 further includes a power gearbox 46, and the fan blades 40, disk 42, and pitch change mechanism 44 are together rotatable about the longitudinal centerline 12 by LP shaft 36 across the power gearbox 46. The power gearbox 46 includes a plurality of gears for adjusting the rotational speed of the fan 38 relative to the rotational speed of the LP shaft 36, such that the fan 38 may rotate at a more efficient fan speed.

Referring still to FIG. 1, the disk 42 is covered by rotatable front hub 48 of the fan section 14 (sometimes also referred to as a “spinner”). The front hub 48 is aerodynamically contoured to promote airflow through the plurality of fan blades 40.

Additionally, the exemplary fan section 14 includes an annular fan casing or outer nacelle 50 that circumferentially surrounds the fan 38 and/or at least a portion of the turbomachine 16. The nacelle 50 is supported relative to the turbomachine 16 by a plurality of circumferentially spaced outlet guide vanes 52 in the embodiment depicted. Moreover, a downstream section 54 of the nacelle 50 extends over an outer portion of the turbomachine 16 to define a bypass airflow passage 56 therebetween.

During the operation of the gas turbine engine 10, a volume of air 58 enters the gas turbine engine 10 through an associated inlet 60 of the nacelle 50 and fan section 14. As the volume of air 58 passes across the fan blades 40, a first portion of air 62 is directed or routed into the bypass airflow passage 56, and a second portion of air 64 as indicated by arrow 64 is directed or routed into the gas flow path 37, or more specifically into the LP compressor 22. The ratio between the first portion of air 62 and the second portion of air 64 is commonly known as a bypass ratio.

The pressure of the second portion of air 64 is then increased as it is routed through the HP compressor 24 and into the combustion section 26 for use in the combustion process. More specifically, the fuel may be supplied to one or more fuel nozzles 80 within the combustion section 26. The fuel delivered to the combustion section 26 by the fuel nozzle(s) 80 mixes within the second portion of air 64. This air-fuel mixture is then combusted or otherwise burned to produce combustion gases 66.

Thereafter, the combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft 34, thus causing the HP shaft 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft 36, thus causing the LP shaft 36 to rotate, thereby supporting operation of the LP compressor 22 and/or rotation of the fan 38.

The combustion gases 66 are subsequently routed through the jet exhaust nozzle section 32 of the turbomachine 16, which defines an outlet 82 to the turbomachine 16. Thus, the combustion gases 66 generate propulsive thrust while exiting the jet exhaust section 32. Simultaneously, the pressure of the first portion of air 62 is substantially increased as the first portion of air 62 is routed through the bypass airflow passage 56 before it is exhausted from a fan nozzle exhaust section 76 of the gas turbine engine 10, also generating propulsive thrust. The HP turbine 28, the LP turbine 30, and the jet exhaust nozzle section 32 at least partially define a hot gas path 78 for routing the combustion gases 66 through the turbomachine 16.

The gas turbine engine 10 depicted in FIG. 1 is by way of example only, and in other embodiments, the gas turbine engine 10 may have any other suitable configuration. For example, although the gas turbine engine 10 depicted is configured as a ducted gas turbine engine (i.e., including the outer nacelle 50), in other embodiments, the gas turbine engine 10 may be an unducted gas turbine engine (such that the fan 38 is an unducted fan, and the outlet guide vanes 52 are cantilevered from the outer casing 18). Additionally, or alternatively, although the gas turbine engine 10 depicted is configured as a geared gas turbine engine (i.e., including the power gearbox 46) and a variable pitch gas turbine engine (i.e., including a fan 38 configured as a variable pitch fan), in other embodiments, the gas turbine engine 10 may additionally or alternatively be configured as a direct drive gas turbine engine (such that the LP shaft 36 rotates at the same speed as the fan 38), as a fixed pitch gas turbine engine (such that the fan 38 includes fan blades 40 that are not rotatable about a pitch axis P), or both. Furthermore, in still other exemplary embodiments, aspects of the present disclosure may be incorporated into any other suitable gas turbine engine. For example, in other exemplary embodiments, aspects of the present disclosure may (as appropriate) be incorporated into, e.g., a turboprop gas turbine engine, a turboshaft gas turbine engine, or a turbojet gas turbine engine.

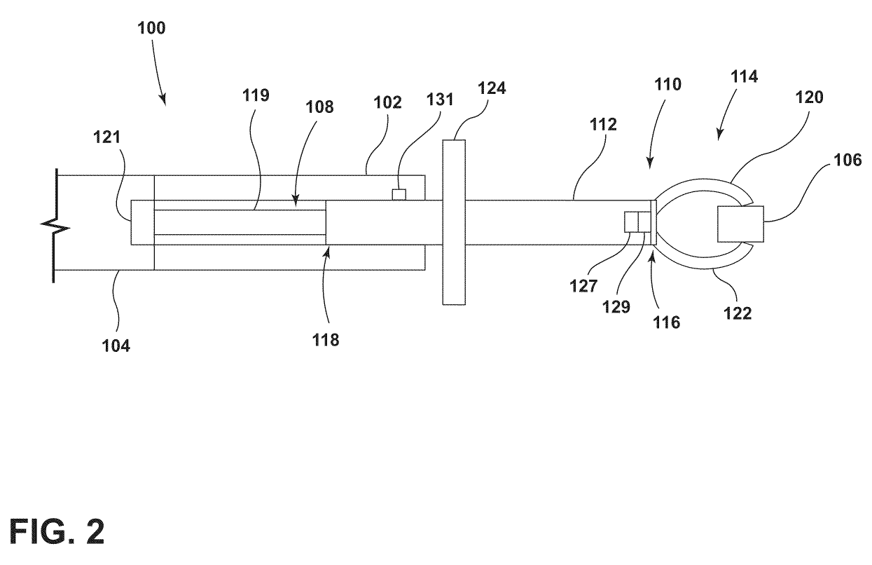

Referring now to FIG. 2, a diagrammatic view of one embodiment of a delivery tool 100 for delivering a compacted cleaning solid into a gas flow path of a gas turbine engine in accordance with aspects of the present disclosure. In general, the delivery tool 100 will be described herein with reference to the gas turbine engine 10 described above with reference to FIG. 1. However, the disclosed delivery tool 100 may generally be utilized with gas turbine engines having any other suitable configuration.

As shown in FIG. 2, the delivery tool 100 includes a base member 102. In general, the base member 102 is configured to couple to and/or support one or more other components of the delivery tool 100. Furthermore, the base member 102 may be configured to be coupled to a robotic arm 104. The robotic arm 104, in turn, may be configured to move or otherwise manipulate the delivery tool 100 in space, such as relative to the gas turbine engine 10 into which a compacted cleaning solid 106 is to be delivered. In several embodiments, the base member 102 may be annular such that the base member 102 defines a passage 108 extending therethrough.

Additionally, the delivery tool 100 includes an insertion member 110 moveable relative to the base member 102. In general, the insertion member 110 is configured to be inserted into the inlet 60 of the gas turbine engine 10. As such, the insertion member 110 may be configured to hold the compacted cleaning solid 106 for eventual placement of the compacted cleaning solid 106 into the gas flow path 37 (e.g., the LP compressor 22) of the gas turbine engine 10. In this respect, the insertion tool 110 is slidable relative to the base member 102, thereby allowing the insertion tool 110 to be extended and retracted relative to the base member 102.

In several embodiments, the insertion member 110 includes a shaft 112 and a gripper 114. Specifically, in such embodiments, the shaft 112 may extend between a first end 116 and a second end 118. As such, the gripper 114 may be coupled to the first end 116 of the shaft 112 and configured to hold the compacted cleaning solid 106 for eventual placement of the compacted cleaning solid 106 into the gas flow path 37 of the gas turbine engine 10. Conversely, the second end 118 of the shaft 112 may be positioned within the passage 108 of the base member 102. In this respect, the shaft 112 may be slideable relative to the base member 102 such that shaft 112 can be retracted into and extended outward from the base member 102 (e.g., via a piston 119 driven by an actuator 121, such as an electric linear actuator). For example, by extending the shaft 112 outward from the base member 102, the gripper 114 (and the compacted cleaning solid 106 the gripper 114 is holding) can be moved into the inlet 60 and along the gas flow path 37 to deliver the compacted cleaning solid 106 to a selected location within the gas turbine engine 10 (e.g., a selected location within the LP compressor 22). Additionally, in some embodiments, the gripper 114 may include first and second jaws 120, 122, which can grip or otherwise hold the compacted cleaning solid 106. For example, the first and second jaws120, 122 may be actuated or otherwise moved between an opened or non-gripping position and a closed or gripping position by an actuator 127 and a suitable gearbox 129.

In other embodiments, the delivery tool 100 includes a tube sized and configured to deliver the compacted cleaning solid 106 through an interior passage of the tube. In this manner, a steady or intermittent flow of compacted cleaning solids 106 may be delivered repeatedly through the delivery tool 100 without first removing the delivery tool 100 from the gas turbine engine 10 to load the compacted cleaning solids 106. The tube may be mounted to a robotic arm 104 or may be mounted to a gas turbine engine component, such as a casing, a borescope port, an inlet cowling, a frame, a strut or a guide vane. In some embodiments, the delivery tool 100 including the tube may be configured to be inserted within a gas flow path 37 of the gas turbine engine 10 through one or more borescope ports, disposed along the length of the booster, the LP compressor 22 etc. in addition to or in lieu of the inlet 60 of the gas turbine engine 10.

Moreover, the delivery tool 100 includes a stopper 124. In general, the stopper 124 is configured to set the distance into the gas flow path 37 that the insertion member 110 places the compacted cleaning solid 106. Specifically, the stopper 124 may be positioned along the length of the shaft 112 between the first end 116 and the second end 116. In this respect, the shaft 112 may be extended relative to the base member 102 and into the gas turbine engine 10 until the stopper 124 contacts the gas turbine engine 10 (e.g., the front surface of the nacelle 50). That is, when the the stopper 124 contacts the gas turbine engine 10, the gripper 114 is positioned at the selected location within the gas turbine engine 10 at which the compacted cleaning solid 106 is to be delivered. Additionally, in some embodiments, the stopper 124 may be adjustably coupled to the shaft 112 (e.g., via Acme threads, a clip, etc.) to allow the position of the stopper 124 along the shaft 112 to be adjusted, such as for use in different gas turbine engines.

In other embodiments, the delivery tool 100 may include one or more sensors 131, such as a camera sensor(s), a proximity sensor(s), or a contact sensor in addition to or in lieu of the stopper 124. The sensor(s) 131 may be used in conjunction with and to control and/or limit the extension of the shaft 112 or in conjunction with and to control and/or limit the motion of the robotic arm 104, in both cases via a computing system (e.g., one or more controllers, such as one or more microcontrollers, microprocessors, and/or the like). For example, in the illustrated embodiment, the sensor(s) 131 is configured as a linear potentiometer configured to detetec movement between the shaft 112 and the base member 102, with such movement being indicative of the extension of the gripper 114 into the gas turbine engine 10.

In addition, one or more components of the delivery tool 100 may be formed from a polymeric material, such as to prevent scratching, scraping, or other damage to the gas turbine engine 10. For example, in some embodiments, the base member 102, the insertion member 110, and/or the stopper 124 may be formed of a polymeric material.

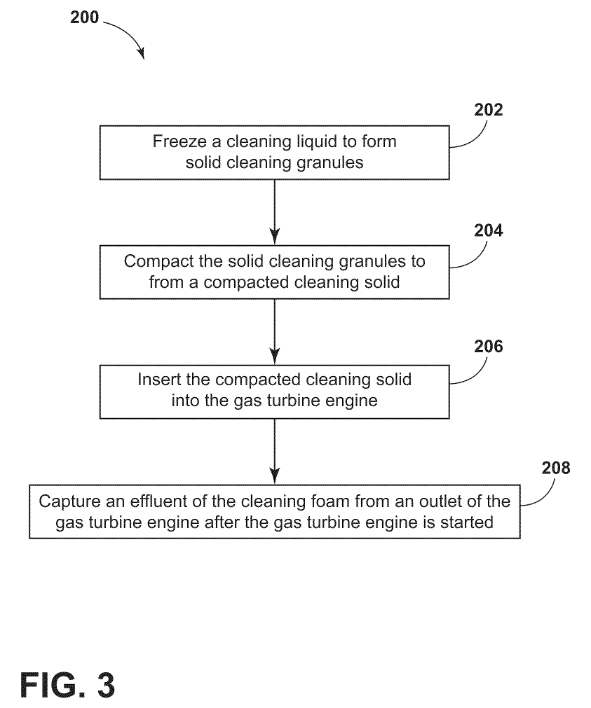

Referring now to FIG. 3, a flow diagram of one embodiment of a method 200 for washing a gas turbine engine is illustrated in accordance with aspects of the present subject matter. In general, the method 200 will be described herein with reference to the gas turbine engine 10 and the delivery tool 100 described above with reference to FIGS. 1 and 2. However, the disclosed method 200 may generally be implemented with any gas turbine engine having any suitable configuration and/or with any delivery tool having any suitable configuration. In addition, although FIG. 3 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 3, at (202), the method 200 includes freezing a cleaning liquid to form solid cleaning granules. Specifically, in several embodiments, when freezing the cleaning liquid at (202), the cleaning liquid may be exposed to liquid nitrogen. In this respect, the liquid nitrogen may provide air bubbles to generate a cleaning foam once inside the gas turbine engine 10. In other embodiments, when freezing the cleaning liquid at (202), the cleaning liquid is frozen to form the solid cleaning granules using a vapor compression cycle. For example, in such embodiments, a refrigerator, a freezer, a chiller, or other similar device using a vapor compression cycle for cooling may be used to the freeze the cleaning liquid. In other embodiments, the cold plate of a Peltier effect cooling device may be used to freeze the cleaning liquid. Moreover, in further embodiments, when freezing the cleaning liquid at (202), the cleaning liquid is embedded within dry ice or solid carbon dioxide. However, in yet further embodiments, the cleaning liquid may be frozen in any other suitable manner.

The cleaning liquid may be any suitable liquid or liquid mixture for cleaning the gas turbine engine 10. For example, in some embodiments, the cleaning liquid may be a detergent (i.e., a liquid detergent). In other embodiments, the cleaning liquid may be a mixture of detergent (i.e., a liquid detergent) and water (i.e., liquid water). In one embodiment, the mixture of water and detergent may be at least ninety percent water by volume, such as at least ninety-five percent water be volume or at least ninety-seven percent water by volume. In such embodiments, the water may be frozen around the detergent such that granules of solid detergent are encapsulated in ice (i.e., there is frozen detergent on the inside and ice on the outside). In other embodiments, the detergent may be frozen around the water such that granules of solid detergent are encapsulated in detergent (i.e., there is frozen detergent on the outside and ice on the inside). Additionally, the cleaning liquid may contain any suitable additive(s), such as a surfactant(s) and/or the like.

As used herein, “granules” refer to pellets, chips, chunks, powders, flakes, or any other small solid pieces that can be compacted or otherwise compressed into a larger solid form.

Furthermore, at (204), the method 200 includes compacting the solid cleaning granules to form a compacted cleaning solid. Specifically, in several embodiments, at (204), the solid cleaning granules may be compacted into one or more spheres, cuboids, and/or the like. For example, the solid cleaning granules formed at (202) may be compacted using a suitable press. In some embodiments, compacting the solid cleaning granules at (204) includes forming the compacted cleaning solid 106 with a size and/or a shape selected based on one or more parameters associated with the gas flow path 37. As will be described below, the compacted cleaning solid will eventually be delivered into the gas flow path 37 of the gas turbine engine 10 for use in removing particulates from or otherwise cleaning the gas turbine engine 10. For example, using the parameter(s) of the gas flow path 37 (e.g., its length, diameter, shape, and/or the like), the size and shape of the compacted cleaning solid 106 can be selected to ensure the compacted cleaning solid 106 will generate sufficient cleaning foam to clean the all or substantially all of the gas flow path 37.

In some embodiments, (202) and (204) may be performed ex-situ. That is, freezing the cleaning liquid and compacting the solid cleaning granules may be performed ex-situ. As used herein, ex situ refers to a remote or offsite location relative to where the cleaning operation is being performed, such as a factory, a staging area, a repair shop, etc.

Conversely, in other embodiments, (202) and (204) may be performed in-situ. That is, freezing the cleaning liquid and compacting the solid cleaning granules may be performed in-situ. As used herein, in situ refers to the location where the cleaning operation is being performed, such as a runway or hangar. For example, in one embodiment, the freezing and compacting may be performed on an vehicle or other device used for inserting the compacted cleaning solid 106 into the gas turbine engine 10.

In some embodiments, the detergent and or water may be frozen in stages. For example, at a first stage, a hollow container made of a detergent or water or a combination thereof is formed by freezing within a mold. The container may include one or more chamber(s) therein, with openings. Each chamber may be used to contain a substance including without limitation one or more of carbon dioxide in solid form (dry ice) or liquid nitrogen, or a concentrated detergent or a catalyst or a reagent. At a second stage, the chamber(s) is at least part-filled with one or more of theaforementioned substances. At a third stage, a cap or lid configured to close the opening(s) to the chamber(s) in the hollow container and made of a detergent or water or a combination thereof, is formed by freezing within a second mould. At a fourth stage, the cap or lid is affixed to the container so as to close the chamber(s), using a quantity of liquid and a further freezing operation.

Additionally, at (206), the method 200 includes inserting the compacted cleaning solid into the gas turbine engine. Specifically, in several embodiments, at (206), the compacted cleaning solid 106 is inserted into the gas flow path 37 of the gas turbine engine 10 through an inlet of the gas turbine engine 10, such as the inlet 60 of the nacelle 50. For example, the compacted cleaning solid 106 may be placed into the LP compressor 22.

In general, when the gas turbine engine 10 is started, the compacted cleaning solid 106 liquifies to form a cleaning foam due to heat generated by the engine and the mechanical agitation provided by the rotor blades within the gas flow path 37. The cleaning foam, in turn, spreads through the gas flow path 37 of the gas turbine engine 10 to clean one or more components of the gas turbine engine 10 along the gas flow path 37 (e.g., the stator vanes and/or turbine blades of the LP and/or HP compressors 22, 24). As indicated above, the melting of the compacted cleaning solid 106 may release nitrogen trapped in the compacted cleaning solid 106 at (202) to form gas bubbles or pockets within the melted cleaning liquid, thereby forming the cleaning foam. Mechanical agitation of the melted cleaning liquid may further impart gas bubbles/pockets within the cleaning foam.

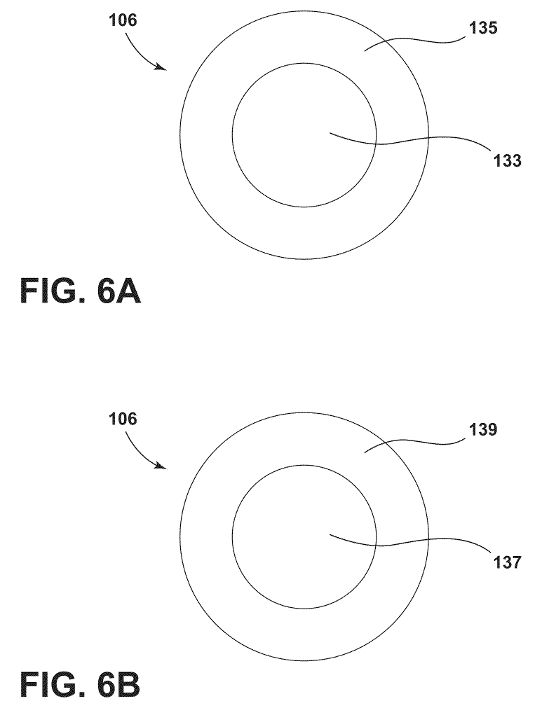

As mentioned above, in some embodiments, water may freeze around the detergent such that there is frozen detergent on the inside of the compacted cleaning solid 106 and ice on the outside of the compacted cleaning solid 106. For example, as shown in FIG. 6A, the compacted cleaning solid 106 includes an inner layer of frozen detergent 133 surrounded or otherwise encapsulated in an outer layer of ice 135. In such embodiments, when the gas turbine engine 10 is started, the ice on the exterior of the compacted cleaning solid may break off due to melting and agitation from the gas turbine engine 10. The ice chips that break off the compacted cleaning solid 106 mechanically clean the one or more components (e.g., the stator vanes and/or rotor blades) along the gas flow path 37 before the frozen detergent liquifies to form the cleaning foam, which subsequently chemically cleans the one or more components. In this respect, the ice chips may provide mechanical or abrasive cleaning, while the cleaning foam may provide chemical cleaning. In some embodiments, the water content of the compacted cleaning solid may be sufficient to flush out all of the detergent. Alternatively, a piece of ice can be placed in the engine 10 after the compacted cleaning solid has worked its way through the engine 10 to provide the water the necessary to flush out all of the detergent.

Moreover, as mentioned above, in some embodiments, the detergent may freeze around the water such that there is frozen detergent on the outside of the compacted cleaning solid 106 and ice on the inside of the compacted cleaning solid 106. For example, as shown in FIG. 6B, the compacted cleaning solid 106 includes an inner layer of ice 137 surrounded or otherwise encapsulated in an outer layer of frozen detergent 139. In such embodiments, when the gas turbine engine 10 is started, the detergent on the exterior of the compacted cleaning solid 106 liquifies to form the cleaning foam, which chemically cleans the one or more components (e.g., the stator vanes and/or rotor blades) along the gas flow path 37. Thereafter, the ice may break apart due to melting and agitation from the gas turbine engine 10. The ice chips that break off the compacted cleaning solid 106 mechanically clean the component(s) along the gas flow path 37 before melting to form water. This water then washes away the cleaning foam from the gas flow path 37.

Furthermore, as mentioned above, in some embodiments, the frozen detergent may be embedded within dry ice or frozen carbon dioxide. In such embodiments, when the gas turbine engine 10 is started, the dry ice chips on the exterior of the compacted cleaning solid 106 may break off due to melting and agitation from the gas turbine engine 10. The dry chips that break off the compacted cleaning solid 106 mechanically clean the one or more components (e.g., the stator vanes and/or rotor blades) along the gas flow path 37 before the detergent liquifies to form the cleaning foam, which subsequently chemically cleans the component(s) along the gas flow path 37.

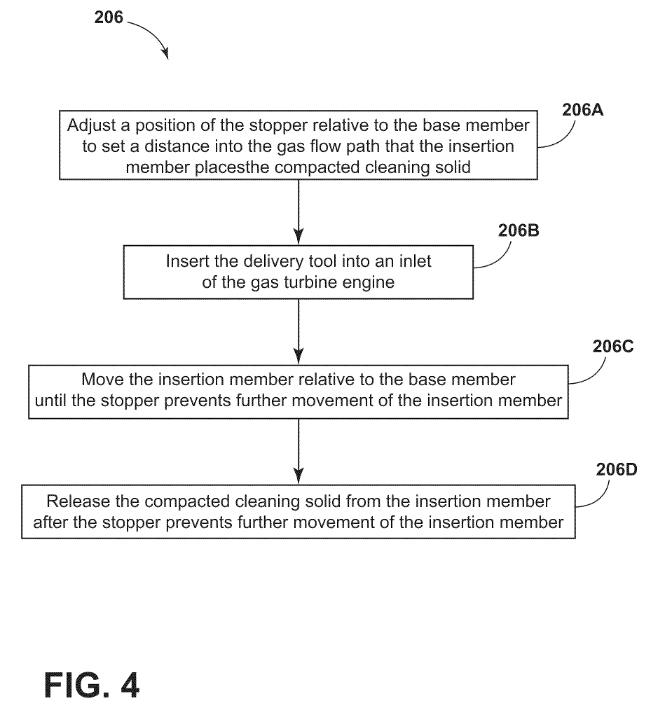

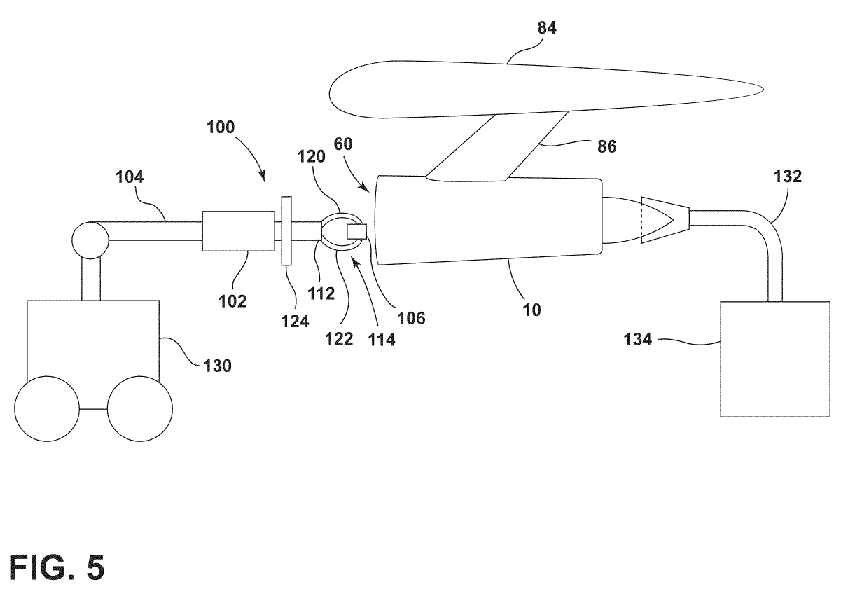

In some embodiments, at (206), the compacted cleaning solid 106 is inserted into the gas turbine engine using the delivery tool 100. In this respect, FIG. 4 is a flow diagram of one embodiment of (206) using the delivery tool 100. Moreover, FIG. 5 is a diagrammatic view of an implementation of (206) using the delivery tool 100.

Specifically, as shown in FIG. 4, at (206A), the position of the stopper is adjusted relative to the base member to set the distance into the gas flow path that the insertion member places the compacted cleaning solid. For example, as shown in FIG. 5, the stopper 124 may be positioned along the shaft 112 to set the distance into the gas turbine engine 10 (e.g., into the LP compressor 22) that the compressed cleaning solid 106 is deposited.

Furthermore, as shown in FIG. 4, at (206B), the delivery tool is inserted into an inlet of the gas turbine engine. For example, as shown in FIG. 5, the delivery tool 100 may be positioned relative to the gas turbine engine 10 such that the gripper 114 holding the compacted cleaning solid 106 is inserted into the inlet 60 of the gas turbine engine 10. For example, in one embodiment, the delivery tool 100 may be coupled to the robotic arm 104, which is, in turn, supported on a vehicle 130. In this respect, the vehicle 130 and/or the robotic arm 104 may be moved to position delivery tool 100 at an appropriate position relative to the gas turbine engine 10.

Additionally, as shown in FIG. 4, at (206C), the insertion member is moved relative to the base member until the stopper prevents further movement of the insertion member. Referring again to FIG. 5, in several embodiments, the shaft 112 may be extended relative to the base member 102 (e.g., via the piston 119 shown in FIG. 2) to insert the the gripper 114 holding the compacted cleaning solid 106 into the inlet 60 of the gas turbine engine 10. In this respect, the shaft 112 is extended until the stopper 124 contacts the gas turbine engine 10 (e.g., the nacelle 50 (FIG. 1) of the gas turbine engine 10), thereby indicating the gripper 114 and the compacted cleaning solid 106 is at the selected position within the gas flow path 37 of the gas turbine engine 10 (e.g., at a selected position within the LP compressor 22). Alternatively, as indicated above, the sensor(s) 131 may be used to determine how far the shaft 112 is extended relative to the base member 102 (e.g., via the piston 119 shown in FIG. 2) to insert the the gripper 114 holding the compacted cleaning solid 106 into the inlet 60 of the gas turbine engine 10 such that the compacted cleaning solid 106 is positioned at the selected position within the gas flow path 37.

Moreover, as shown in FIG. 4, at (206D), the compacted cleaning solid is released from the insertion member after the stopper prevents further movement of the insertion member. Referring again to FIG. 5, in several embodiments, the gripper 114 may release the compacted cleaning solid 106 after the stopper 124 contacts the gas turbine engine 10. For example, in one embodiment, the first and second jaws 120, 122 may open to release the compacted cleaning solid 106.

Referring again to FIG. 3, at (208), the method 200 includes capturing an effluent of the cleaning foam from an outlet of the gas turbine engine after the gas turbine engine is started. More specifically, after the compacted cleaning solid 106 is deposited within the gas flow path 37 of the gas turbine engine 10, the gas turbine engine 10 may be started. As the gas turbine engine 10 spools up (e.g., while parking on or adjacent to the runway or in a hanger), the compacted cleaning solid 106 is heated and liquifies to form a cleaning foam. For example, the nitrogen trapped in the compacted cleaning solid due to the freezing at (202) and the mechanical agitation of the gas turbine engine 10 creates the gas bubbles or pockets in the liquified cleaning product, thereby forming the cleaning foam. The cleaning foam spreads through a gas flow path 37 of the gas turbine engine 10 to clean one or more components (e.g., the stator vanes and/or rotor blades) of the gas turbine engine 10 along the gas flow path 37. Additionally, in embodiments in which the cleaning liquid that is frozen includes water or dry ice, the associated ice chips formed as the compacted cleaning solid 106 breaks apart may provide a mechanical or abrasive cleaning and the cleaning foam may provide a chemical cleaning. Thereafter, as shown in FIG. 5, the used cleaning foam may exit the gas turbine engine 10 as an effluent, which is capture by an effluent capture device 132 and collected in a tank 134 for eventual disposal. Moreover, in embodiments in which ice is present within interior of the compacted cleaning solid 106 (e.g., frozen detergent forms the exterior of the compacted cleaning solid 106 and ice forms the interior of the compacted cleaning solid 106), the ice may melt and wash away to the cleaning foam when the effluent is formed.

For example, in some embodiments, the compacted cleaning solids release one or more reagents contained therein into the gas turbine engine 10 as they are broken up either by a melting process, or by the starting up of the gas turbine engine 10, or by rotation of one or more of the the shafts 34, 36 using a turning motor permanently or removably installed on the gas turbine engine 10, so that a reaction occurs within the gas turbine engine 10 to promote a cleaning effect. The reaction may be a selected exothermic reaction configured to warm the liquid detergent within the gas turbine engine 10 to a higher temperature than the compacted cleaning solids, such as to greater than 50 degrees Celsius, to greater than 75 degrees Celsius or to greater than 80 degrees Celsius. The reagents may be a pair of acids and alkalis, which react to produce pH neutral reaction products. The acids and alkais may be selected to act as cleaning agents individually for a short period before they react and are neutralized. A reaction product may be a gas, which may promote formation of a foam.

Additionally, as shown in FIG. 5, the method 200 may be performed when the gas turbine engine 10 is supported on an aircraft wing 84 via a strut 86. Therefore, the example method 200 does not require removal of the gas turbine engine 10 from the aircraft wing 84. This enables the method 300 to be performed relatively quickly and reduces aircraft time-on-ground.

Further aspects are provided by the subject matter of the following clauses:

A method for washing a gas turbine engine, the method includes: freezing a cleaning liquid to form solid cleaning granules; compacting the solid cleaning granules to form a compacted cleaning solid; and inserting the compacted cleaning solid into the gas turbine engine, wherein when the gas turbine engine is started, the compacted cleaning solid liquifies to form a cleaning foam, which spreads through a gas flow path of the gas turbine engine to clean one or more components of the gas turbine engine along the gas flow path.

The method of one or more clauses, wherein freezing the cleaning liquid comprises exposing the cleaning liquid to liquid nitrogen.

The method of one or more clauses, wherein freezing the cleaning liquid comprises freezing a cleaning liquid to form the solid cleaning granules using a vapor compression cycle.

The method of one or more clauses, wherein freezing the cleaning liquid comprises embedding the cleaning liquid within dry ice such that, when the gas turbine engine is started, the dry ice mechanically cleans the one or more components and the cleaning liquid chemically cleans the one or more components.

The method of one or more clauses, wherein the cleaning liquid is a liquid detergent.

The method of one or more clauses, wherein the cleaning liquid is a mixture of liquid detergent and water.

The method of one or more clauses, wherein the water is frozen on an exterior of the compacted cleaning solid such that, when the gas turbine engine is started, ice chips break off the compacted cleaning solid to mechanically clean the one or more components before the detergent liquifies to form the cleaning foam, which subsequently chemically cleans the one or more components.

The method of one or more clauses, wherein the detergent is frozen on an exterior of the frozen cleaning granules such that, when the gas turbine engine is started, the detergent liquifies to form the cleaning foam, which chemically cleans the one or more components, before ice chips subsequently break off the compacted cleaning solid to mechanically clean the one or more components and eventually melt to wash away the cleaning foam.

The method of one or more clauses, wherein compacting the solid cleaning granules comprises forming the compacted cleaning solid with at least one of a size or a shape selected based on one or more parameters associated with the gas flow path.

The method of one or more clauses, wherein freezing the cleaning liquid and compacting the solid cleaning granules are performed ex-situ.

The method of one or more clauses, wherein freezing the cleaning liquid and compacting the solid cleaning granules are performed in-situ.

The method of one or more clauses, wherein inserting the compacted cleaning solid into the gas turbine engine comprises inserting the compacted cleaning solid into the flow path through an inlet of the gas turbine engine.

The method of one or more clauses, wherein inserting the compacted cleaning solid into the gas turbine engine comprises inserting the compacted cleaning solid into the gas turbine engine using a delivery tool including a base member, an insertion member moveable relative to the base, and a stopper adjustably coupled to the insertion member.

A delivery tool for delivering a compacted cleaning solid into a gas flow path of a gas turbine engine, the delivery tool comprising: a base member; an insertion member slidable relative to the base member, the insertion member configured to hold the compacted cleaning solid for eventual placement of the compacted cleaning solid into the gas flow path, anda stopper configured to set a distance into the gas flow path that the insertion member places the compacted cleaning solid.

The delivery tool of one or more clauses, wherein the insertion member comprises a shaft extending from a first end to a second end, the insertion member further comprising a gripper coupled to the first end and configured to hold the compacted cleaning solid for eventual placement of the compacted cleaning solid into the gas flow path.

The delivery tool of one or more clauses, wherein the gripper comprises first and second jaws.

The delivery tool of one or more clauses, wherein the base member is annular such that the base member define a passage extending therethrough.

The delivery tool of one or more clauses, wherein the second end of the shaft is positioned within the passage such that the shaft is slideable relative to the base member.

The delivery tool of one or more clauses, wherein a position of the stopper relative to the shaft is adjustable to set the distance into the gas flow path that the insertion member places the compacted cleaning solid.

The delivery tool of one or more clauses, wherein the insertion member is configured to be inserted into an inlet of the gas turbine engine.

This written description uses examples to disclose the present disclosure, including the best mode, and also to enable any person skilled in the art to practice the disclosure, including making and using any devices or systems and performing any incorporated methods. The patentable scope of the disclosure is defined by the claims and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. A method for washing a gas turbine engine, the method comprising:
freezing a cleaning liquid to form solid cleaning granules;
compacting the solid cleaning granules to form a compacted cleaning solid; and
inserting the compacted cleaning solid into the gas turbine engine,
wherein when the gas turbine engine is started, the compacted cleaning solid liquifies to form a cleaning foam, which spreads through a gas flow path of the gas turbine engine to clean one or more components of the gas turbine engine along the gas flow path.

2. The method of claim 1, wherein freezing the cleaning liquid comprises exposing the cleaning liquid to liquid nitrogen.

3. The method of claim 1, wherein freezing the cleaning liquid comprises freezing a cleaning liquid to form the solid cleaning granules using a vapor compression cycle.

4. The method of claim 1, wherein freezing the cleaning liquid comprises embedding the cleaning liquid within dry ice such that, when the gas turbine engine is started, the dry ice mechanically cleans the one or more components and the cleaning liquid chemically cleans the one or more components.

5. The method of claim 1, wherein the cleaning liquid is a liquid detergent.

6. The method of claim 1, wherein the cleaning liquid is a mixture of liquid detergent and water.

7. The method of claim 6, wherein the water is frozen on an exterior of the compacted cleaning solid such that, when the gas turbine engine is started, ice chips break off the compacted cleaning solid to mechanically clean the one or more components before the detergent liquifies to form the cleaning foam, which subsequently chemically cleans the one or more components.

8. The method of claim 6, wherein the detergent is frozen on an exterior of the solid cleaning granules such that, when the gas turbine engine is started, the detergent liquifies to form the cleaning foam, which chemically cleans the one or more components, before ice chips subsequently break off the compacted cleaning solid to mechanically clean the one or more components and eventually melt to wash away the cleaning foam.

9. The method of claim 1, wherein compacting the solid cleaning granules comprises forming the compacted cleaning solid with at least one of a size or a shape selected based on one or more parameters associated with the gas flow path.

10. The method of claim 1, wherein freezing the cleaning liquid and compacting the solid cleaning granules are performed ex-situ.

11. The method of claim 1, wherein freezing the cleaning liquid and compacting the solid cleaning granules are performed in-situ.

12. The method of claim 1, wherein inserting the compacted cleaning solid into the gas turbine engine comprises inserting the compacted cleaning solid into the flow path through an inlet of the gas turbine engine.

13. The method of claim 1, wherein inserting the compacted cleaning solid into the gas turbine engine comprises inserting the compacted cleaning solid into the gas turbine engine using a delivery tool including a base member, an insertion member moveable relative to the base, and a stopper adjustably coupled to the insertion member.

14. A delivery tool for delivering a compacted cleaning solid into a gas flow path of a gas turbine engine, the delivery tool comprising:
a base member;
an insertion member slidable relative to the base member, the insertion member configured to hold the compacted cleaning solid for eventual placement of the compacted cleaning solid into the gas flow path; and
a stopper configured to set a distance into the gas flow path that the insertion member places the compacted cleaning solid.

15. The delivery tool of claim 14, wherein the insertion member comprises a shaft extending from a first end to a second end, the insertion member further comprising a gripper coupled to the first end and configured to hold the compacted cleaning solid for eventual placement of the compacted cleaning solid into the gas flow path.

16. The delivery tool of claim 15, wherein the gripper comprises first and second jaws.

17. The delivery tool of claim 15, wherein the base member is annular such that the base member define a passage extending therethrough.

18. The delivery tool of claim 17, wherein the second end of the shaft is positioned within the passage such that the shaft is slideable relative to the base member.

19. The delivery tool of claim 15, wherein a position of the stopper relative to the shaft is adjustable to set the distance into the gas flow path that the insertion member places the compacted cleaning solid.

20. The delivery tool of claim 14, wherein the insertion member is configured to be inserted into an inlet of the gas turbine engine.
